(19) United States
(12) Patent Application Publication
(10) Pub. No.: US 2007/0033009 A1
(43) Pub. Date: Feb. 8, 2007

(54) Apparatus and method for modulating voice in portable terminal

(75) Inventor: Yang-Muk Kang, Gumi-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/395,256

(22) Filed: Apr. 3, 2006

(30) Foreign Application Priority Data
Aug. 5, 2005 (KR) 2005-71729

(51) Int. Cl. G10L 19/00

(52) U.S. Cl. 704/201

(57) ABSTRACT

An apparatus and method are provided for modulating voice in a portable terminal. Voice data is modulated so that a user can listen to a desired voice. A memory module is provided for storing the type of voice data modulation and a coefficient value of a filter performing voice data modulation according to the type of the voice data modulation A voice modulation module is provided for modulating the voice data by employing the coefficient value of the voice data modulation filter according to the type of the voice data modulation stored in the memory module, and a controller is provided for determining if the set-up for modulating voice data has been prepared when the voice data are received. The controller controls the voice modulation module to modulate the voice data by applying the coefficient value of the filter performing the voice data modulation and outputs the modulated voice.

### PRIORITY

This application claims the benefit under 35 U.S.C. § 119(a) of Korean Patent Application No. 2005-71729, filed Aug. 5, 2005, in the Korean Intellectual Property Office, the entire contents of which are hereby incorporated by reference.

### BACKGROUND OF THE INVENTION

1. Field of the Invention

The present invention relates to a portable terminal. More particularly, the present invention relates to an apparatus and a method for modulating voice in a portable terminal.

2. Description of the Related Art

Through conventional voice modulation in a portable terminal, a user's voice is modulated into a preset voice through a predetermined menu input of the portable terminal and transmitted such that the modulated voice is output to a portable terminal speaker of a counterpart terminal. In addition, if a user's voice is transmitted through a microphone, voice data received from the portable terminal of the user may be modulated in a predetermined area existing on a network, thereby allowing modulation of the user's voice and transmission to a counterpart portable terminal.

Accordingly, conventional voice modulation is performed through a terminal of a call transmitter and transmitted to a portable terminal of a receiver. In this manner, the portable terminal of the receiver can receive the modulated voice and output the modulated voice through a speaker.

### SUMMARY OF THE INVENTION

Accordingly, the present invention has been made to address the above-mentioned problems occurring in the prior art. It is an exemplary object of the present invention to provide an apparatus and method for outputting voice data desired by a user by modulating voice data received in a portable terminal.

To accomplish the above and other objects, there is provided, according to an exemplary embodiment of the present invention, an apparatus for modulating voice data in a portable terminal. The apparatus comprises a memory module for storing a type of voice data modulation for modulating received voice data. The memory module can also store a coefficient value of a filter performing voice data modulation according to type of voice data modulation. The apparatus further comprises a voice modulation module for modulating voice data by employing the coefficient value of the voice data modulation filter according to type of voice data modulation stored in the memory module, and a controller for determining if set-up for modulating the voice data is prepared when the voice data are received, controlling the voice modulation module to modulate the voice data by applying the coefficient value of the filter performing the voice data modulation according to the type of voice data modulation based on a determination result, and controlling the modulated voice to be output.

According to another exemplary aspect of the present invention, there is provided a method for modulating voice data in a portable terminal. The method comprises receiving voice data in the portable terminal, modulating the received voice data according to type of voice data modulation, and outputting the modulated voice data.

### BRIEF DESCRIPTION OF THE DRAWINGS

The above and other objects, exemplary features and advantages of the present invention will be more apparent from the following detailed description of exemplary embodiments taken in conjunction with the accompanying drawings, in which:

FIG. 1 is a block diagram illustrating the entire structure of a portable terminal according to an exemplary embodiment of the present invention;

FIG. 2 is a flowchart illustrating the operational procedure according to an exemplary embodiment of the present invention;

FIG. 3 is a flowchart illustrating the operational procedure of extracting a coefficient value of voice modulation according to an exemplary embodiment of the present invention; and

FIG. 4 is a flowchart illustrating the operational procedure of modulating voice data according to an exemplary embodiment of the present invention.

Throughout the drawings, like reference numbers should be understood to refer to like elements, features, and structures.

### DETAILED DESCRIPTION OF EXEMPLARY EMBODIMENTS

The matters exemplified in this description are provided to assist in a comprehensive understanding of various exemplary embodiments of the present invention disclosed with reference to the accompanying figures. Accordingly, those of ordinary skill in the art will recognize that various changes and modifications of the exemplary embodiments described herein can be made without departing from the scope and spirit of the claimed invention. Descriptions of well-known functions and constructions are omitted for clarity and conciseness.

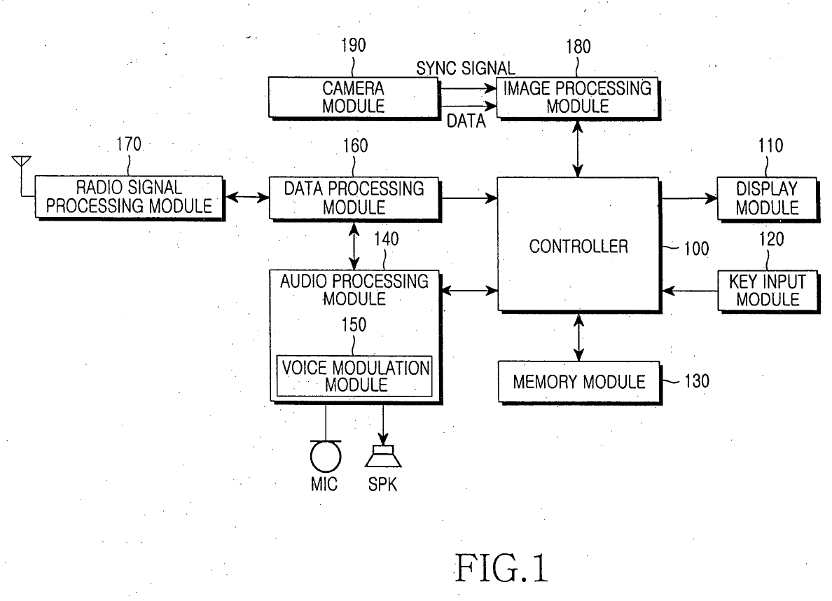

FIG. 1 is a block diagram illustrating the entire structure of a portable terminal according to an exemplary embodiment of the present invention. A controller 100 controls operating functions of the modules of the portable terminal according to the present invention. In particular, the controller 100 can confirm frequency characteristics of voice data input through a radio signal processing module 170. In addition, the controller 100 can determine whether to modulate received voice data or whether to modulate voice data during output and control the voice data to be modulated according to a time point of determining voice data. The controller 100 controls the modulated voice data to be output to a speaker connected to an audio processing module 140.

A display module 110 displays a current state, each processing state, and each operation state according to a key input from a key input module 120 under the control of controller 100. The display module 110 may employ a liquid crystal display (LCD). The display module 110 may comprise an LCD controller, a memory capable of storing image data, and an LCD display element. When the LCD is realized through a touch screen scheme, the key input module 120 and the LCD may become input modules. The display module 110 comprises an image data displaying module which outputs image data. If the controller 100 determines that a signal allowing modulation of voice data received through the radio signal processing module 170 is received, the display module 110 according to an exemplary embodiment of the present invention displays the types of voice modulation which may be set by a user. The types of voice modulation displayed on the display module 110 according to an exemplary embodiment of the present invention may be classified into a hi-tone boost mode, a mid-tone boost mode, and a bass-tone boost mode. In addition, when the type of voice modulation is set by a user, the display module 110 displays the voice data modulation progress in the set type of voice modulation.

A key input module 120 comprises a plurality of numeral keys and various function keys for performing a variety of functions and outputs an electrical signal to the controller 100 corresponding to the key data input of a user. The key input module 120 according to an exemplary embodiment of the present invention is used for inputting a signal allowing modulation of the received voice data. In addition, the key input module 120 enables a user to select one of the types of voice modulation displayed on the display module, 110 according to the signal input and thereby allow voice modulation. According to an exemplary embodiment of the present invention, the user may select at least one of a hi-tone boost mode, a mid-tone boost mode, and a bass-tone boost mode which are the types of voice data modulation displayed on the display module.

A memory module 130 stores programs performed in the controller 120 or temporarily stores data processed by the programs. In addition, the memory module 130 stores received short messages and a phone number table. This memory module 130 comprises a read only memory (ROM) storing an operating system program, an electrically erasable programmable ROM (EEPROM), and a read access memory (RAM). The memory module 130 according to an exemplary embodiment of the present invention stores a filter coefficient value used for modulating voice according to the type of voice data modulation for modulating the received voice. Accordingly, the memory module 130 outputs the filter coefficient value stored therein to a voice modulation module 150 when the type of voice data modulation for the modulation of the input voice data is selected by the user.

The audio processing module 140 may comprise a CODEC, and the CODEC comprises a data CODEC for processing packet data and an audio CODEC for processing an audio signal such as voice. The audio processing module 140 reproduces a digital audio signal received in the data processing module 160 by converting the digital audio signal into an analog signal through the audio CODEC, or transmits an analog audio signal generated from a microphone to the data processing module 160 by converting the analog audio signal into a digital audio signal through the audio CODEC. The CODEC may be separate from the controller 100, or may be included in the controller 100. The audio processing module 140 according to an exemplary embodiment of the present invention comprises the voice modulation module 150 for modulating received voice data according to the type of voice data modulation set by a user. The voice modulation module 150 modulates the received voice data by adjusting the coefficient value of the voice modulation filter stored in the memory module 180 according to the type of voice data modulation set. Thereafter, the audio processing module 140 outputs the modulated voice data through the speaker connected thereto. Although the voice modulation module 150 is included in the audio processing module 140 according to the present invention, the voice modulation module 150 may be included in the controller 100. In addition, although not shown, a memory module for setting voice modulation may be included in the voice modulation module 150 without storing the filter coefficient value and the type of voice data modulation for the modulation of the voice modulation module 150 in the memory module 180.

The radio signal processing module 170 makes communication of a mobile communication terminal. The radio signal processing module 170 comprises a radio frequency (RF) transmitter for up-converting and amplifying a frequency of a signal to be transmitted and an RF receiver for low-noise amplification of a received signal and down-converting a frequency of the received signal.

The data processing module 160 comprises a transmitter for encoding and modulating the signal to be transmitted and a receiver for de-modulating and de-coding the received signal.

A camera module 190 comprises a camera sensor for photographing an image to make an image file and converting an optical signal into an electrical signal, and a signal processing module for converting an analog image signal photographed by the camera sensor into a digital file. In an exemplary embodiment of the present invention, the camera sensor may be a charge-coupled device (CCD) sensor, and the signal processing module may be realized using a digital signal processor (DSP). In addition, the camera sensor may be integrated with, or separate from the signal processing module.

An image processing module 180 creates an image file used for displaying an image signal output from the camera module 190. The image processing module 180 processes the image signal output from the camera module 190 in a frame unit and outputs a frame image file corresponding to the characteristic and size of the display module 100. In addition, the image processing module 180 comprises an image CODEC to compress a frame image file displayed on the display module 110 in a preset scheme, or de-compress the compressed image file into an original frame image file. The image CODEC may be, for example, a JPEG CODEC, an MPEG4 CODEC, and a Wavelet CODEC. It is assumed that the image processing module 180 comprises an “on screen display” function, and the image processing module 180 may output the “on screen display” file according to the size of the displayed screen image under the control of controller 100.

As described above, when the portable terminal according to an exemplary embodiment of the present invention is set in such a manner that voice data is modulated, the portable terminal has a structure comprising a display module 110 for displaying types of voice data modulation, a key input module 120 allowing selection of one among a plurality of types of voice data modulation displayed on the display module 110, a memory module 130 for storing a coefficient value for voice modulation according to the selected type of voice data modulation, a voice modulation module 180 enabling modulation of the voice data according to the coefficient value of the voice modulation, and a control module 100 for controlling operation of the function modules and performing a control operation in such a manner that the modulated voice data are output to the speaker.

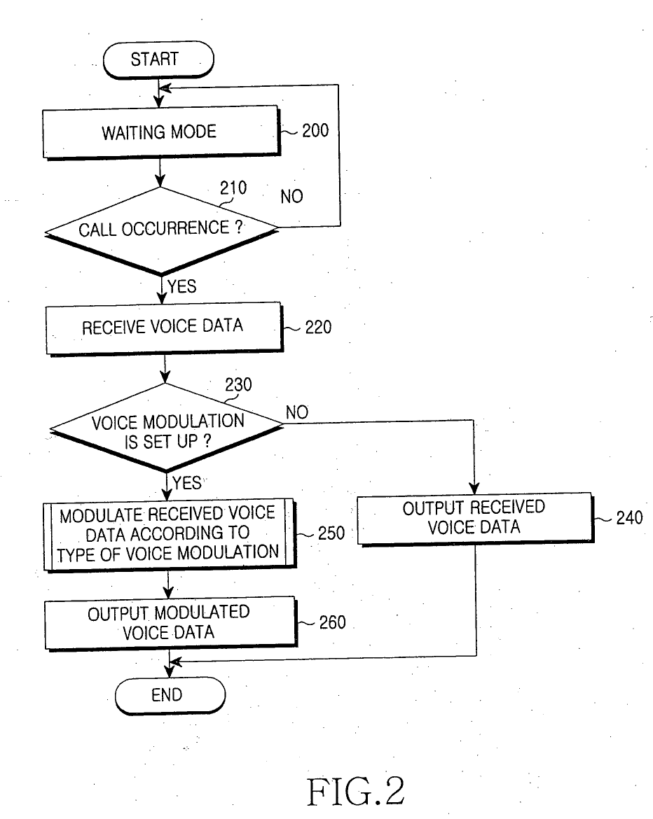

FIG. 2 is a flowchart illustrating the operational procedure according to an exemplary embodiment of the present invention. The controller 100 of the portable terminal enters a waiting mode, step 200. When a predetermined signal is generated in the waiting mode, the controller 100 determines if the generated signal is a signal reporting call occurrence in step 210. If it is determined that the generated signal is a signal reporting call occurrence, the controller 100 receives voice data through the radio signal processing module 170 of the portable terminal according to the call occurrence in step 220. The controller 100 then determines if voice data modulation allowing for modulation of the received voice data is set in step 230. If it is determined that the voice data modulation is not set, the controller 100 outputs the received voice data through a speaker connected to the audio processing module 140 in step 240. In contrast, if it is determined that the voice data modulation is set in step 230, the controller 100 controls the voice modulation module 150 to modulate the received voice data according to the type of voice data modulation previously selected by the user in step 250. Thereafter, when the controller 100 confirms that the voice modulation module 150 finishes the modulation of voice data, the controller 100 controls the modulated voice data to be output through the speaker connected to the audio processing module 140 in step 260.

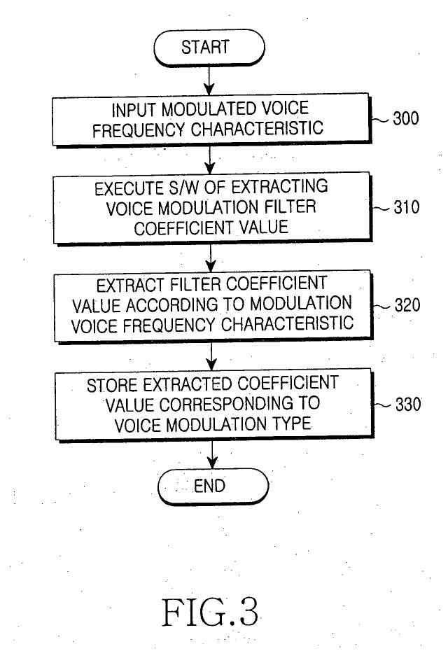

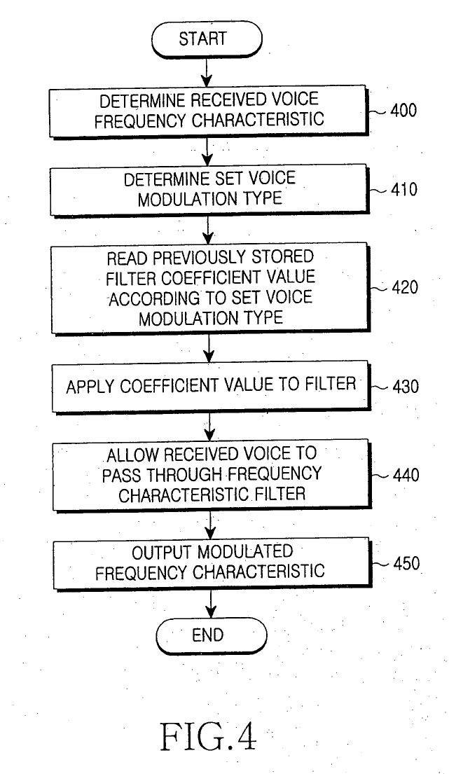

FIG. 3 is a flowchart illustrating the operating procedure of extracting a coefficient value of voice modulation for a voice modulation operation according to an exemplary embodiment of the present invention. FIG. 4 is a flowchart illustrating the operation for modulating received voice data according to an exemplary embodiment of the present invention. Hereinafter, the operation of extracting the filter coefficient value of the voice modulation for the received voice data will be described with reference to FIG. 3. In addition, the operation of modulating the received voice data according to the preset type of voice modulation as a function of the extracted filter coefficient value of the voice modulation in step 250 of FIG. 2 will be described. In step 300, the controller 100 provides a frequency characteristic of voice modulation for extracting the filter coefficient value of the voice modulation. Thereafter, the controller 100 executes software for extracting the filter coefficient value of the voice modulation in step 310 if the controller 100 detects input of the frequency characteristic of the modulation voice. In step 320, the controller 100 extracts the filter coefficient value of voice modulation according to the frequency characteristic of the voice modulation through the executed software. Accordingly, in step 330, the controller 100 stores the extracted filter coefficient value in the memory module 180 in such a manner that the extracted filter coefficient value corresponds to the type of voice modulation classified as, for example, a hi-tone boost mode, a mid-tone boost mode, or a bass-tone boost mode. The controller 100 of the portable terminal extracts the filter coefficient value by executing a program to extract the filter coefficient value stored in the memory module 180. In addition, a computer storing software for extracting the filter coefficient value may extract the filter coefficient value by executing the software. Accordingly, the filter coefficient value extracted by executing the software stored in the computer may be stored in the memory module 180 of the portable terminal.

Referring to FIG. 4, if it is determined in step 230 that the set-up for modulating the received voice data is prepared, the controller 100 determines the frequency characteristic of the received voice in step 400. In addition, the controller 100 determines the type of voice data modulation preset by a user in step 410. Thereafter, in step 420, the controller 100 reads the filter coefficient value according to the type of voice data modulation preset by the user, which is previously stored in the memory module 180, according to the result of step 400. The controller 100 outputs the filter coefficient value of voice modulation read from the memory module 180 in step 420 to the voice modulation module 150 and controls the voice modulation module 150 so as to apply the filter coefficient value to a filter allowing for modulation of the received voice data in step 430. Thereafter, the controller 100 performs filtering with respect to the received voice data by means of the filter to which the filter coefficient value of voice modulation is applied, step 440, and outputs the modulated frequency characteristic in step 450.

While the invention has been particularly shown and described with reference to certain exemplary embodiments thereof, it will be understood by those of ordinary skill in the art that various changes in form and detail may be made therein without departing from the spirit and scope of the present invention as defined by the appended claims and equivalents thereof.

What is claimed is:

1. An apparatus for modulating voice data in a portable terminal, the apparatus comprising:
a memory module for storing a type of voice data modulation for modulating voice data and for storing a coefficient value of a filter adapted to perform voice data modulation according to the type of voice data modulation;
a voice modulation module for modulating voice data by employing the coefficient value of the voice data modulation filter according to the type of voice data modulation stored in the memory module; and
a controller for determining if set-up for modulating voice data is prepared when the voice data are received, controlling the voice modulation module to modulate the voice data by applying the coefficient value of the voice data modulation filter according to the type of voice data modulation based on a determination result, and controlling output of the modulated voice.

2. A method for modulating voice data in a portable terminal, the method comprising:
receiving voice data;
modulating the received voice data according to type of voice data modulation; and
outputting the modulated voice data.

3. The method as claimed in claim 2, wherein the type of voice data modulation comprises at least one of a hi-tone boost mode, a mid-tone boost mode, and a bass-tone boost mode according to a voice data modulation frequency characteristic.

4. A method for modulating voice data in a portable terminal, the method comprising:
determining if set-up for modulating voice data is prepared when the voice data are received;
modulating the voice data according to type of voice data modulation when the set-up for the modulation of the voice data is prepared; and
outputting the modulated voice data.

5. The method as claimed in claim 4, wherein the type of voice data modulation comprises at least one of a hi-tone boost mode, a mid-tone boost mode, and a bass-tone boost mode according to a voice data modulation frequency characteristic.

6. The method as claimed in claim 4, further comprising:
reading a voice modulation coefficient value; and
modulating the received voice data by employing the voice modulation coefficient value.

7. The method as claimed in claim 6, wherein reading the voice modulation coefficient value comprises:
inputting a voice data modulation frequency characteristic;
extracting the voice modulation coefficient value according to the voice data modulation frequency characteristic; and
storing the extracted voice modulation coefficient value by grouping the extracted voice modulation coefficient value corresponding to the type of voice data modulation.

8. The method as claimed in claim 6, wherein the voice data modulation coefficient value is stored according to the preset type of the voice data modulation.

9. The method as claimed in claim 7, wherein the inputting comprises inputting the voice data modulation frequency characteristic into software.

10. A method for modulating voice data in a portable terminal, the method comprising the steps of:
extracting a voice data modulation coefficient value by inputting a preset frequency characteristic of the voice data modulation into predetermined software;
storing the extracted voice data modulation coefficient value;
reading the voice data modulation coefficient value according to a preset type of the voice data modulation if setting up for modulation of the received voice data is prepared when the voice data is received; and
modulating the received voice data according to the preset type of the voice data modulation by adjusting the read voice data modulation coefficient value.

11. The method as claimed in claim 10, wherein the type of voice data modulation comprises at least one of a hi-tone boost mode, a mid-tone boost mode, and a bass-tone boost mode according to the voice data modulation frequency characteristic.
